(19) United States
(12) Patent Application Publication
(10) Pub. No.: US 2022/0044244 A1
(43) Pub. Date: Feb. 10, 2022

(54) INCREMENTAL ADDITION TO AN AUGMENTED GRAPH MODEL

(71) Applicant: PayPal, Inc., San Jose, CA (US)

(72) Inventor: Zhe Chen, Singapore (SG)

(21) Appl. No.: 17/386,058

(22) Filed: Jul. 27, 2021

Related U.S. Application Data
(60) Provisional application No. 63/061,992, filed on Aug. 6, 2020.

(51) Int. Cl. G06Q 20/40; G06Q 40/02; G06F 16/901; G06F 16/28; G06N 20/00

(52) U.S. Cl. CPC G06Q 20/405; G06Q 40/02; G06Q 20/4016; G06Q 30/0204; G06F 16/285; G06N 20/00; G06F 16/9024

(57) ABSTRACT

A computer system accesses an augmented graph model of (a) a set of transactions previously performed between respective pairs of initiator user accounts of a service and recipient user accounts of the service and (b) attribute values for a subset of the recipient user accounts. The computer system receives additional information indicative of an additional transaction involving an additional recipient user account that is not represented in the augmented graph model with a node. The computer system modifies the augmented graph model using the additional information and groups the user accounts represented in the modified augmented graph model into a plurality of groups.

### CROSS-REFERENCE TO RELATED APPLICATION

The present application claims the benefit of U.S. Provisional Appl. No. 63/061,992 filed on Aug. 6, 2020; which is incorporated by reference herein in its entirety.

### BACKGROUND

### Technical Field

This disclosure relates generally to analyzing transactions between user accounts of a service to determine subsets of user accounts of the service.

### Description of the Related Art

With the advent of large-scale computer storage capacity, it has become possible to store massive amounts of information about how a computer-implemented service is used. For example, if a service facilitates transactions between user accounts of the service, information about these user accounts and records of these transactions can be stored for analysis. Taken together, information about various user accounts and the transactions between these user accounts can be analyzed to derive insights into the security and performance of the service.

### BRIEF DESCRIPTION OF THE DRAWINGS

FIG. 1 is a block diagram illustrating an embodiment of a computer system configured to determine subsets of accounts using a model of transactions in accordance with the disclosed embodiments.

FIG. 2 is a flowchart depicting an embodiment of an account subset determining method.

FIG. 3 is an exemplary table of recipient user accounts in accordance with the disclosed embodiments.

FIG. 4A-B are a series of pictures illustrating an exemplary process of nodes being grouped into subsets in accordance with the disclosed embodiments.

FIG. 5 is a series of pictures illustrating an exemplary process of nodes being regrouped into subsets in accordance with the disclosed embodiments.

FIG. 6 is flowchart illustrating an embodiment of a user account subset determining method in accordance with the disclosed embodiments.

FIG. 7 is flowchart illustrating an embodiment of a user account subset determining method in accordance with the disclosed embodiments.

FIG. 8 is a flowchart depicting an embodiment of an incremental account subset determining method 800.

FIG. 9 is a flowchart depicting a process of adding additional nodes to an augmented graph model in accordance with various embodiments

FIG. 10 is a flowchart depicting a process of grouping additional nodes in accordance with various embodiments.

FIGS. 11A-B are a serious of pictures illustrating examples of incrementally adding nodes to an augmented graph model in accordance with various embodiments.

FIG. 12 is flowchart illustrating an embodiment of an incremental node additional method in accordance with the disclosed embodiments.

FIG. 13 is a block diagram of an exemplary computer system, which may implement the various components of FIG. 1.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computer system configured to access” is intended to cover, for example, a computer system has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, references to “first” and “second” user accounts would not imply an ordering between the two unless otherwise stated.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

“In this disclosure, various “modules” operable to perform designated functions are shown in the figures and described in detail (e.g., model module 120, subset determination module, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.”

### DETAILED DESCRIPTION

Many computer-implemented services record voluminous data about the users of such computer-implemented services, these users' transactions with the computer-implemented services, and/or these users' transactions with each other. Analyzing this voluminous data may reveal important insights about the performance of the computer-implemented service, the users, or their transactions with each other. Because the amount of data can be so large, in various embodiments, the techniques used process this data balance the speed at which the data is processed and the amount of computer resources utilized against qualities of the resulting analysis.

In various embodiments, from among the various users (and their respective accounts), a computer system may be able to analyze the data about the users and their transactions to identity subsets of user accounts (also referred to herein as groups of user accounts) that include user accounts that share characteristics. In some instances, such characteristics may be characteristics of the user (e.g., one subset may include user accounts for users that are corporate entities, another subset may include user accounts for users that are natural people), characteristics of the user accounts (e.g., one subset may include user accounts that are accessed on a daily basis, another subset may include user accounts that are used more infrequently), and/or characteristics of the transactions between user accounts (e.g., one subset may include user accounts that engage in infrequent but large value transactions, another subset may include user accounts that engage in multiple transactions per day and are relatively smaller value). Such characteristics, however, may not be discretely identifiable into such categories and are grouped as a result of modularity-based grouping algorithms. In a sense these subsets represent “communities” of user accounts.

These community groupings may be useful in various applications including network security, risk management, compliance management, and targeted marketing. A service (e.g., a transaction service) may use the community groupings to respond differently to different groups of user accounts in different communities. For example, the computer-implemented service may apply different sets of polices (including risk score thresholds) to these community groupings to detect unauthorized transactions (e.g., sales of contraband, sales with maliciously taken-over user accounts) and intercede (e.g., by preventing future transactions, by banning offending user accounts). In another example, members of a community that infrequently use the service but engage in large value transactions can be sent marketing messages to increase use of the service based on the community grouping. In still another example, a first community of users with brick-and-mortar stores may be assigned lower risk scores than a second community of users without brick-and-mortar stores, and the higher risk score of the second community may be used to flag transactions with members of the second community for additional scrutiny (e.g., against fraud, against sale of contraband).

In U.S. patent application Ser. No. 16/440,149 entitled “Determining Subsets of Accounts Using a Model of Transactions” filed Jun. 13, 2019, the inventor described a framework named Augmented Graph with Modularity Maximization and Refinement (AGGMMR) useable to identify such groups of user accounts using records of transactions and attribute information about various user accounts. In various embodiments, the AGGMMR framework partitions an augmented graph model based on both its attributes and topological information through a greedy modularity maximization algorithm. AGGMMR consists of three phases: (i) augmented graph construction and weight initialization, (ii) weight learning with modularity maximization, and (iii) modularity refinement.

The AGGMMR framework, however, was initially designed for use with static graphs (i.e., once the graph is constructed and groups of user accounts are identified, no additional nodes or edges representing additional user accounts or transactions are added). The present disclosure teaches various techniques allowing additional transactions to be incrementally added to the AGGMMR framework. This incremental AGGMMR (inc-AGGMMR) framework is usable to add representations of transactions to an augmented graph model that was generated using the AGGMMR framework without rebuilding the entire augmented graph model from scratch and to adjust groupings of user accounts as the network of nodes evolves.

### System Architecture

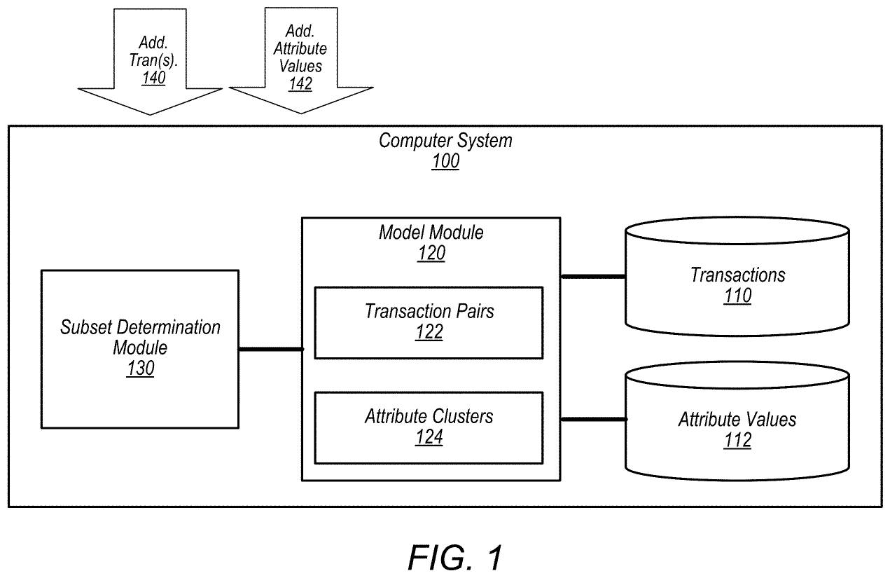

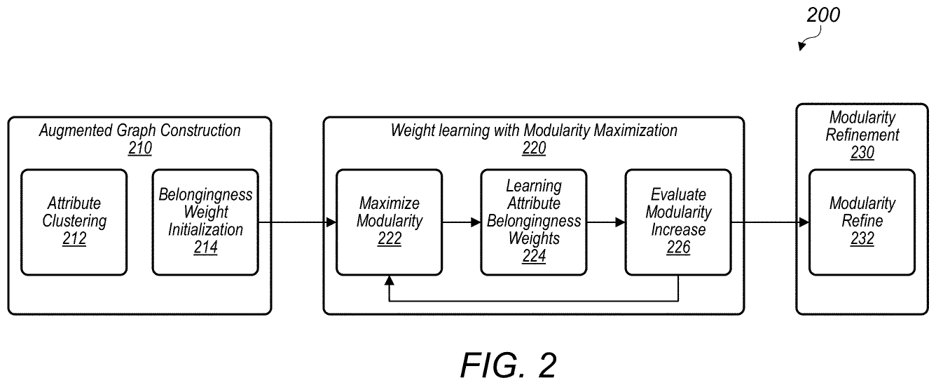

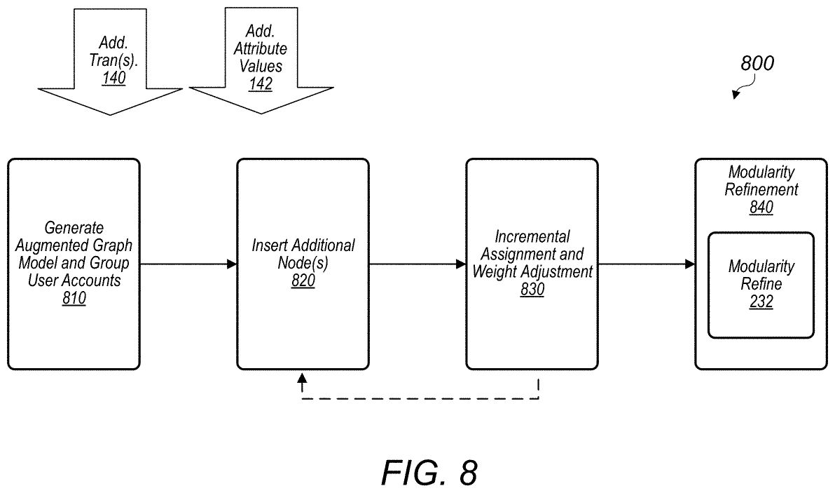

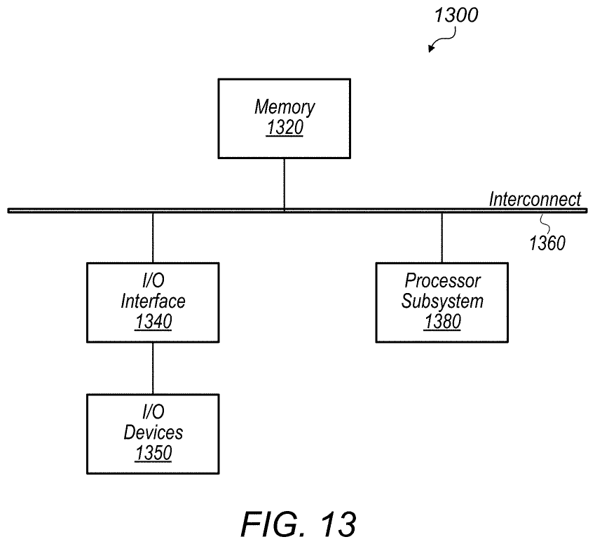

Referring now to FIG. 1, a block diagram illustrating an embodiment of a computer system 100 configured to determine subsets of accounts using a model of transactions is depicted. Computer system 100 includes a database storing a transaction set 110, a database storing an attribute values set 112, a modeling module 120 executable to generate a model using transactions set 110 and attribute values set 112, and a subset determinization module 130 that is executable to determine subsets of nodes within the model generated by modeling module 120. In various embodiments, the database storing transaction set 110 and the database storing attribute values set 112 are separate as shown in FIG. 1, but in various embodiments, transaction set 110 and attribute values set 112 are maintained in the same database. The generation of the model of transactions and the grouping of user accounts according to the AGGMMR framework is discussed in reference to FIGS. 2-7. Computer system 100 is also operable to receive indications of additional transactions 140 and additional attribute values 142 and incrementally add representations of the additional transactions 140 and additional attribute values 142 to the AGGMMR framework using the inc-AGGMMR techniques discussed in reference to FIGS. 8-13.

Transactions set 110 includes information that describes a set of transactions between pairs of user accounts of a service (e.g., a file storage service, a payment service). Similarly, indications of additional transactions 140 describe transactions between pairs of user accounts of the service. In various embodiments, such transactions are purchases in which monetary value is exchanged for a good or service in the context of a marketplace or payment service. In other embodiments, however, transactions can be any exchange between accounts including but not limited to exchanges of files in a file storage service or exchanges of messages in an electronic mail service. Each transaction is between a pair of user accounts that includes an “initiator user account” (i.e., the user account associated with the entity that starts the transaction) and a “recipient user account” (i.e., the user account associated with the entity that responds to the transaction). For example, in various embodiments, initiator user accounts are buyer user accounts, the recipient user accounts are seller user accounts, and each transaction corresponds to a purchase between a given buyer user account and a given seller user account.

Attribute values set 112 includes information that specifies attribute values for user accounts of the service that are recipient user accounts within transaction set 110. Similarly, indications of additional attribute values 142 specifies attribute values for a user account that is involved with an additional transaction 140. In such embodiments, such additional attribute values 142 are added to attribute values set 112. In various embodiments, such attribute values describe aspects of a given recipient account or the entity that is associated with the given recipient account (e.g., a business, an individual, etc.). In various embodiments, recipient accounts describe location or business region of the entity, number of employees working for the entity, the corporate form of the entity, whether the entity has taken out a loan, what kinds of products or services the entity is offering, the last time the recipient account was accessed, the last time a transaction was made with the recipient account, the average time between accesses of the recipient account, the average time between transactions made with the recipient account, whether the recipient account has acted as an initiator account in other transactions, etc. In various embodiments, only a subset of recipient accounts has associated attribute values in attribute values set 112 (or in additional attribute values 142). In some of such embodiments, no initiator accounts have attribute values in attribute values set 112 (or in additional attribute values 142), although in other embodiments, when initiator accounts in first transactions can also be used as recipient accounts in second transactions and have associated attribute values in attribute values set 112 (or in additional attribute values 142). Moreover, in various embodiments, not all of the recipient accounts that have attribute values in attribute values set 112 (or in additional attribute values 142) have the same set of attribute values. For example, in various instances small entities (e.g., single proprietorships) and larger entities (e.g., corporations) have respective recipient accounts but only larger entities have attribute values describing the entity associated with the recipient account. In other embodiments, recipient accounts associated with small entities have no attribute values in attribute values set 112 (or in additional attribute values 142).

As discussed in further detail herein in reference to FIG. 2, such attribute values in attribute values set 112 may be recorded as different data types (e.g., attribute values may be numerical, categorical, many-value, or multi-value). Accordingly, in various embodiments, heterogenous sets of attribute values are associated with only a subset of recipient user accounts in transactions set 110. These user accounts that are associated with attribute values are also referred to herein as “attributed user accounts” and when such attributed user accounts are represented by nodes in an augmented graph model discussed herein, such nodes are also referred to herein as “attributed nodes.” In the dataset used by the inventor, for example, transaction set 110 recorded 1.5 billion transactions between 100 million different user accounts, 3 million of which were described by 68 attribute values in attribute values set 112.

Modeling module 120 is useable to generate an augmented graph model of the transactions in transactions set 110 that retains the attribute values of attribute values set 112. In various embodiments, the augmented graph model represents a plurality of transaction pairs 122 from transaction set 110 as respective nodes connected by edges and uses attribute clusters 124 represented in the augmented graph model using cluster nodes to represent attribute values. In various embodiments, such cluster nodes are disposed at center points of the clusters, and in such embodiments may be referred to herein as “center point nodes.” It will be understood, however, the term “cluster node” as used herein refers to a node that represents an attributed cluster, whether or not the attribute node is disposed at the center point of the cluster. As discussed herein in additional detail with reference to FIG. 2, each transaction in transaction set 110 is between a pair of user accounts: an initiator user account and a recipient user account. These user accounts are represented in the augmented graph model as nodes (also referred to herein as “vertices”) with edges representing transactions between the pair of nodes associated with the transaction. In various embodiments and discussed in further detail with reference to FIG. 2, modeling module 120, using transactions set 110, generates a graph model (i.e., a graph model that is not augmented) specifying nodes representing user accounts and the set of transactions as edges between pairs of nodes. Then, modeling module 120 augments such a graph model with attribute values from attribute values set 112 by identifying a plurality of attribute clusters 124 among attributed nodes of the graph model, representing the attribute clusters 124 in the augmented graph model as center point nodes (also referred to herein as “vertices”), and connecting each center point nodes to the attributed nodes clustered in its respective attribute cluster 124.

In various embodiments, subset determination module 130 determines, using the augmented graph model, a plurality of subsets of recipient user accounts. As discussed above, in various instances, these subsets include user accounts that share characteristics. In a sense, a particular subset of attributed nodes (and therefore attributed user accounts) belongs to a “community” because of they are grouped in the same subset. These community groupings may be that useful in various applications including network security, risk management, compliance management, and targeted marketing. In various embodiments, subset determination module 130 uses modularity maximization applied to the attributed nodes in a sequence to make a first grouping of the attributed nodes into subsets of user accounts and then refine the first grouping to make a second grouping in which some attributed nodes are resorted into revised subsets of user accounts. In various embodiments, the subset determination module 130 and modeling module 120 adjust attribute edges as part of the first grouping, and the adjusted attribute edges are used in further groupings in the first grouping and in the second grouping.

The techniques described herein enable determination of subsets (also referred to herein as community detection) from among large scale augmented graph networks. These techniques are able to utilize both the topological information of the augmented graph network as well as attribute values (represented in embodiments in the augmented graph network as additional nodes). These techniques, unlike previous augmented graph analysis techniques, are able to scale and analyze large networks (e.g., at least on the scale of 100 million user accounts and 1.5 billion transactions), analyze networks containing heterogenous nodes (e.g., nodes without attributes and attributed nodes, and attributed nodes with different numbers of attribute values) and different types of attribute values. After determining these subsets of user accounts, computer system 100 is able to flag the recipient user accounts in a particular subset for review (e.g., to determine whether these user accounts pose a security risk or compliance risk to the network), send messages to the recipient user accounts in a particular subset (e.g., marketing messages, warnings about security risks or compliance risks). In some embodiments, computer system is able to assign respective risk scores to one or more over the subsets and, based on the risk scores, evaluate transactions (e.g., past transactions in transaction set 110 or incoming transactions) associated with one or more user accounts in the subsets.

### Generating an Augmented Graph Model and Grouping User Accounts Using AGGMMR

Referring now to FIG. 2, a flowchart depicting an embodiment of an account subset determining method 200 is shown. In the embodiment shown in FIG. 2, the various actions associated with method 200 are implemented by computer system 100. In various embodiments, the AGGMMR framework shown in method 200 is designed to partition an attributed graph based on its attributes and topological information, through a greedy modularity maximization model. In various embodiments, method 200 includes three phases: an augmented graph construction phase 210, a weight learning with modularity maximization phase 220, and a modularity refinement phase 230.

In various embodiments discussed herein, in augmented graph construction phase 210, an augmented graph model is constructed using attributed clustering to retain attribute relationships between vertices. Attribute relationships are then transformed into edges in the augmented graph model. In weight learning with modularity maximization phase 220, modularity maximization is used to partition the augmented graph model-which now contains both attributes and topological information-into subsets of vertices. Along with the partitioning, weights on those attribute relationships according to their contributions toward partitioning the vertices into subsets. In modularity refinement phase 230, a greedy search technique is used to optimize the result of phase 220 and reduce the effect of processing order on the partitioning.

In augmented graph construction phase 210, transactions set 110 and attribute values set 112 are used to generate an augmented graph model that includes both attribute information and topological information. In various embodiments, a graph model can be constructed that represents transaction set 110 as a group of nodes representing the user accounts and edges between the nodes representing transactions between user accounts. In various embodiments, the graph model can be augmented to retain information from the attribute values set 112. In some embodiments, all of the values of the attribute values set 112 can be plotted on the graph model and with additional nodes and then be connected to the original nodes to create an augmented graph model. For example, if there are 100 attributes each with 10 different values in a graph model consisting of 1,000,000 vertices, this method will generate 100×10 additional vertices and 100×1M additional edges.

In other embodiments, instead of directly using attribute values as additional values, a number of attribute clusters can be identified using attribute values set 112, a center point of each attribute cluster can be identified, the center points of each attributed cluster 124 can be represented in the graph model using a center point node, and attribute edges connect the center point nodes to their member vertices to retain the attribute relationships and to thereby generate the augmented graph model. Using this technique, the attributed values set 112 is summarized in the augmented graph model without having to plot each attribute value individually. In various instances, the result is that fewer additional nodes and edges are added to the augmented graph model, which conserves computer processing and memory utilization. For example, if there is a graph model with 1,000,000 vertices and 10, 000 attribute clusters, only 10,000 additional vertices and at most 1,000,000 attribute edges are needed to construct an augmented graph model. Accordingly, useful attribute relationships are effectively captured in this much smaller augmented graph. Moreover, as discussed herein, this technique is also not limited to generating an augmented graph model that only includes categorical attributes. Instead, this technique can be used with all types of attributes as long as the attributes are available for clustering (e.g., numerical attributes clustered using k-means clustering, categorical attributes clustered using k-prototype clustering as discussed herein, attributes that are in a format useable by a clustering algorithm as a parameter). Moreover, this technique is compatible with all kinds of center-based attribute clustering algorithm, and not merely the techniques disclosed herein.

At block 212, computer system 100 performs attribute clustering. In various embodiments, a clustering algorithm such as k-means clustering (or k-prototype clustering discussed herein) can be applied to cluster attributed nodes (i.e., nodes representing user accounts for which attribute information is included in attribute values set 112) into a number of attribute clusters. In various embodiments, other clustering algorithms than k-means or k-prototype can be used, including but not limited to mean-shift clustering, Expectation-Maximization (EM) Clustering using Gaussian Mixture Models (GMM), singular value decomposition, Density-Based Spatial Clustering of Applications with Noise (DBSCAN), and Agglomerative Hierarchical Clustering. In various embodiments, the number of attribute clusters can be set manually, or automatically (e.g., based on the number of attributed user accounts in attribute values set 112). In various embodiments, these attributed nodes are clustered into the number of attribute clusters in a manner that reduces variance between the attributed nodes in the same cluster. In various embodiments, the clustering algorithm identifies, for each respective attribute cluster, a center point that is the centroid of the various nodes in that attribute cluster. The center point of each attribute cluster is then represented in the graph model using a center point node. Then, the attribute nodes in each respective attribute 124 cluster are connected to the center point node for the respective cluster with an attribute edge. The attribute edge weight for this attribute edge is discussed herein in connection to block 214.

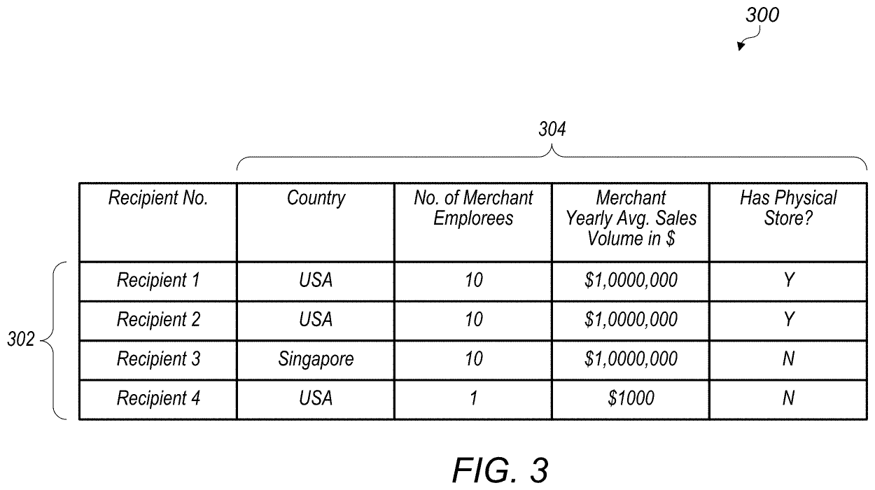

Referring now to FIG. 3, a simplified attribute values set 112 is shown represented as a table 300. As shown in FIG. 3, table 300 includes four recipient user accounts 302, each having four attribute values 304, although in other embodiments, there may be many ore recipient user accounts and attribute values (e.g., millions of recipient user accounts and dozens of attribute values). As discussed herein, these attribute values are clustered using one or more clustering algorithms and the recipient user accounts are grouped with the nearest cluster. Applying the techniques described above in connection to block 212 using table 300 as attribute values set 112, these four recipient user accounts 302 will be clustered into K groups. Assuming that K=3 here (this number can be manually set or determined automatically as discussed herein), these merchants will be clustered into three attributed clusters. For example, after k-means clustering (or k-prototype clustering) the attributed notes representing Recipient 1 and Recipient 2 are clustered into attribute cluster A, the attributed node representing Recipient 3 is clustered into attribute cluster B, and the attributed node representing Recipient 4 is clustered into attribute cluster C. Then, the center point nodes representing the center of each of attribute cluster A, B, and C are added to a graph model generated with transaction set 110. Then, the attributed nodes representing Recipient 1 and Recipient 2 are connected to the center point node for attribute cluster A with attribute edges, the attributed node representing Recipient 3 is connected to the center point nodes for attribute cluster B with an attribute edge, and the attributed node representing Recipient 4 is connected to the center point node for attribute cluster C, resulting in the augmented graph model for transaction set 110 and attributed values set 112. In various embodiments, each attributed node is only connected to a single center point node.

At block 212, computer system 100 performs attribute edge weight initialization. Once the center point nodes for the attribute clusters are added to the graph model, the attributed nodes in the respective attribute clusters are connected to the center point node for that cluster by an attributed edge having an attribute edge weight. To indicate the strength of relationship between each node and its nearest attribute center point node, attribute distance is used to initialize the weight of the attribute edge. In various embodiments, attribute distance is the distance between each vertex and their nearest attribute center point node, calculated by the center-based attribute clustering algorithm. In some embodiments, for example, Euclidean distance can be used if a k-means algorithm is used to cluster attribute values. Herein, attribute distance is denoted by d(vᵢ,v_{c}) between vertex vᵢ and attribute center v_{c}.

In various embodiments, Euclidean distances are calculated as attribute distances, and then mapped into probability values. More particularly, Euclidean distances can be mapped into higher dimensional space using the radial basis function (RBF) kernel shown in Equation 1:

$$P ( {v}_{i} , {v}_{c} ) = exp ( \frac{- d ( {v}_{i} , {v}_{c} )}{2 {σ}^{2}} ) \qquad Equation 1$$

As the kernel distance embeds isometrically in a Euclidean space, the RBF kernel function is an effective metric for weighting observations in various embodiments. Then the weight initialization on attribute edges are calculated using Equation 2:

w(vᵢ,v_{c})=dt(vᵢ)×P(vᵢ,v_{c}) Equation 2:

Here, dt(vᵢ) is the weighted degree of vertex vᵢ in the graph model (i.e., the original graph before adding attribute centers as additional vertices). This weighting scheme is designed to balance the weights between attribute information and topological information for each vertex in the augmented graph at the initial stage in various embodiments.

Referring again to FIG. 2, in weight learning with modularity maximization phase 220, computer system 100 analyzes the augmented graph model generated in augmented graph construction phase 210. As discussed herein, in the augmented graph, both topological relationships (e.g., transactions between nodes) and attribute values (e.g., center point nodes connected to attributed nodes by attribute edges) are represented by edges. Accordingly, in phase 220, computer system 100 could employ any suitable topological based clustering method to partition the augmented graph. Intuitively, densely connected vertices should be in a community as they share either strong attributes or strong topological relationships, or both. In various embodiments, computer system 100 employs modularity maximization in phase 220 to partition the graph as discussed below. In such embodiments, determining the plurality of subsets using modularity maximization is performed such that each of the attributed nodes is grouped in the subset of recipient user accounts that maximizes modularity gain over entire the augmented graph model.

At block 222, computer system 100 performs a modularity maximization to sort attributed nodes into communities based on both the topological relationships and attributes. In various embodiments, Equation 3 below is employed at block 222:

$$Q = \frac{1}{2 m} {\sum }_{i j} [ {A}_{ij} - \frac{da ( {v}_{i} ) \times da ( {v}_{j} )}{2 m} ] δ ( {v}_{i} , {v}_{j} ) \qquad Equation 3$$

In Equation 3, Q is the modularity, m corresponds to the cardinality of edges in the augmented graph model, da(vᵢ), da(vⱼ) are the weighted degrees of vertices vᵢ and vⱼ in the augmented graph model, respectively. Aᵢⱼ is the ij-th component of the adjacency matrix of the augmented graph model, and Aᵢⱼ equals to edge weight if vertices vᵢ and vⱼ are adjacent, and 0 otherwise. δ(vᵢ, vⱼ) equals to 1 when vᵢ and vⱼ belongs to the same community, and to 0 otherwise.

In various embodiments, the Louvain algorithm for modularity maximization is used. In such embodiments, at the beginning of modularity maximization, each vertex is assigned with an individual community. In every iteration, each vertex is compared with its neighbors' community assignments, and assigned to the one with maximum modularity gain. The computation of modularity gain is based on the weights of the edges.

In various embodiments, at block 222 vertices are partitioned on both attributes and topological relationships. Since both types of relationships are represented by edges, there are three situations in which two vertices are assigned a same community through modularity maximization: (i) They are densely connected and they have strong attribute relationships. (ii) They are densely connected but they have trivial attribute relationships. (iii) They are not densely connected but their attribute relationships are strong enough to connect them.

At block 224, computer system 100 performs a learning algorithm to learn the attribute edge weights. In various instances, some attribute relationships could be trivial for many communities. Accordingly, minimizing the influence from such trivial attribute relationships and increasing the importance of meaningful attribute relations improves the performance of method 200 in various embodiments. To this end, an unsupervised weight learning algorithm that is aligned with the modularity maximization objective can be employed to automatically adjust the weights for attribute relationships according to their contributions in the clustering in various embodiments.

For example, if most vertices from a first attribute cluster 124 have been assigned to the same community in an iteration, then this attributed-based relationship from the first attribute cluster 124 provides positive contribution to the community detection task. In contrast, if most of the vertices from a second attribute cluster 124 have been assigned to a large number of different communities, then this attribute-based relationship is very weak and might introduce noise to our task. The weights of attribute edges to the center point nodes for these attribute clusters 124 therefore can be adjusted accordingly. In various embodiments, to update weights of attribute edges, clustering contribution score is calculated for each respective attribute cluster 124 as represented by that attribute cluster's center point node. In such embodiments, each of these contribution scores is respectively indicative of a contribution of the respective attribute cluster 124 to the determining of the plurality of subsets of recipient user accounts relative to other attribute clusters. As discussed below, a given contribution score is then useable to adjust the attribute edge weights for attributed nodes connected to the center point node corresponding to the given contribution score. In various embodiments, the contribution score for an attribute cluster 124, denoted by Θₐ is calculated through Equation 4:

Θₐ=|Vₐ|/|Cₐ|. Equation 4:

In Equation 4, Vₐ is the set of vertices that connect to this attribute center; Cₐ is the set of communities that the member vertices in Vₐ are assigned to through modularity maximization in the current iteration. The value of Θₐ is bounded between 1 to |Vₐ| as |Cₐ| varies from 1 to |Vₐ|. The more vertices an attribute cluster 124 connects, the higher potential contributions this attribute cluster 124 will have. That is, an attribute cluster 124 connecting to 10,000 vertices and all its vertices distributed in the same community contributes more than an attribute center who connects only 10 vertices in the same situation.

To meet the constraint that the total edge weights does not change, i.e., Σᵢ₌₁ⁿwᵢ^{t+1}=Σᵢ₌₁ⁿ wᵢ^{t+1} where wᵢ^{t+1}, is the weight of an attribute edge in iteration t+1, the weights of the attribute edges are redistributed as follows using Equations 5-7:

$$\begin{matrix}{w}_{i}^{t + 1} = \frac{1}{2} ( {w}_{i}^{t} + δ {w}_{i}^{t} ) & Equation 5 \\ δ {w}_{i}^{t} = \frac{{θ}_{a}}{\sum θ} \times W & Equation 6 \\ W = \sum {w}^{t} & Equation 7\end{matrix}$$

In various instances, then, in each iteration, the weights are adjusted towards the direction of increasing the modularity objective. Rewriting the modularity maximization (Equation 3) for this augmented graph model, results in Equations 3.1, 3.2, and 3.3:

$$\begin{matrix}Q = \frac{1}{2 m} ( {Q}_{s} + {Q}_{d} ) & Equation 3.1 \\ {Q}_{s} = \frac{1}{2 m} {\sum }_{lk} [ {A}_{lk} - \frac{d a ( {v}_{l} ) \times d a ( {v}_{k} )}{2 m} ] δ ( {v}_{l} , {v}_{k} ) & Equation 3.2 \\ {Q}_{d} = \frac{1}{2 m} {\sum }_{i j} [ {A}_{i j} - \frac{d a ( {v}_{i} ) \times d a ( {v}_{j} )}{2 m} ] δ ( {v}_{i} , {v}_{j} ) & Equation 3.3\end{matrix}$$

where vₗ,vₖ are vertices that belong to a same attribute center and vᵢ,vⱼ are vertices that belong to different attribute centers. δ(·,·) is the same as in Equation 3, and its value is 1 if the two vertices are in the same community and 0 otherwise.

At block 226, computer system 100 evaluates the modularity increase of the modularity maximization. As discussed above, analyzing an augmented graph model using modularity maximization is performed such that each of the attributed nodes is grouped in the subset of recipient user accounts that maximizes modularity gain over entire the augmented graph model. In various instances, the modularity of an augmented graph model is in proportion to the sum of differences between connections and expected connections from every pair of vertices that are in a same community. In the above Equations 3.1, 3.2 and 3.3, Qₛ represents the sum of modularity calculated from the pairs of vertices in a same attribute clusters 124 and Q_{d} represents the sum of modularity calculated from the pairs of vertices in different attribute clusters 124. Weight learning, however, affects the modularity of Qₛ more than Q_{d} and as such the modularity of Q_{d} changes to a lesser extent when weights are adjusted. In each iteration, each center point node will also be assigned to one of its member's communities according to its relationships with its members. When the weights of attribute relationships from an attribute cluster 124 are increased, Aₗₖ between the member vertices to the center point node representing the attribute cluster 124 also increased. In this way, Qₛ is increased more as most of vertices are likely to be assigned into the same community with the center point node for that attribute cluster 124. In contrast, when the weights of attribute relationships are decreased, Q_{d} decreases less because most of the vertices connect to the center point node for the attribute cluster 124 are assigned into different communities.

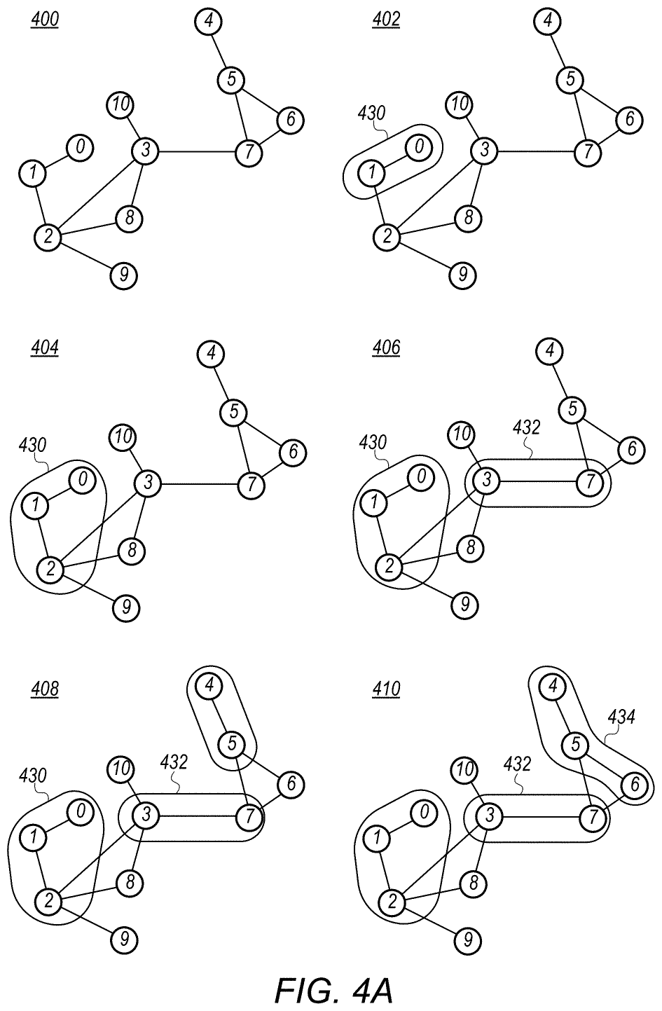

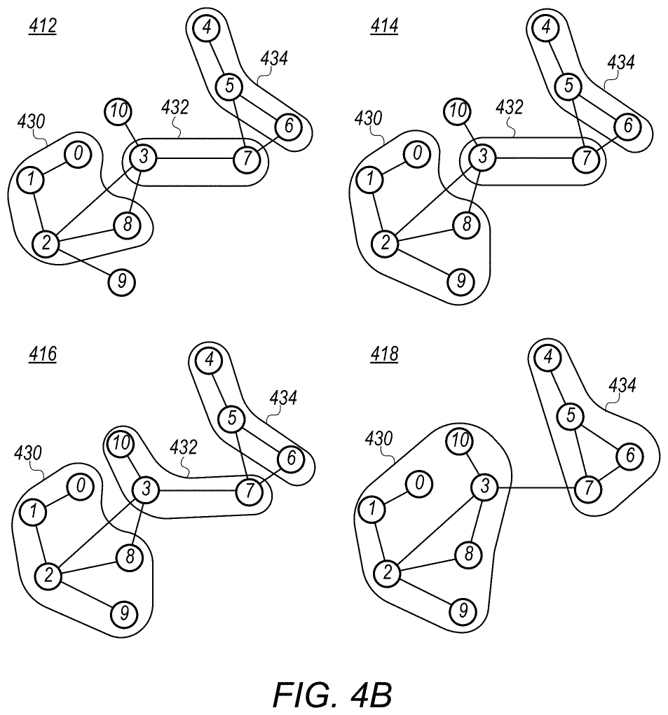

Referring now to FIGS. 4A and 4B, a series of pictures illustrating an exemplary process of nodes being grouped into subsets in accordance with the disclosed embodiments is shown. In various embodiments, the nodes are grouped into communities using the modularity maximization techniques discussed herein in reference to modularity maximization phase 220 in FIG. 2.

In various embodiments, the modularity maximization phase 220 is a “greedy” algorithm in which in each stage/iteration the local optimum is selected with the intent of finding a global optimum. In embodiments, greedy modularity maximization reduces computation cost significantly, however, but the result is significantly affected by the order of processing. In such embodiments, to find the community assignments which maximize the global modularity of an augmented graph model, in each step, a vertex is assigned into one of its neighbors' communities. In such embodiments, then, a sub-task to finding a particular local optimal community assignment is to find optimal community assignments for previous n vertices. This recursion can be expressed as Equation 8:

Q[n]=max(Q₁[n−1]+q_{n-1,n},Q₂[n−2]+q_{n-2,n} . . . ) Equation 8:

In Equation 8, the Qₖ [n−k] represents the optimal community assignments for previous n−k vertices while q_{n-k,n} represents the later k vertices' assignments. However, in this greedy method, this recursion can be expressed with simplified Equation 8.1:

Q[n]=Q₁[n−1]+q_{n-1,n} Equation 8.1:

The community assignment of a given vertex thus depends on the previous assignments. In some embodiments, for the application of modularity maximization used herein, it is assumed that the previous assignments for n−1 vertices are always the optimum solution even after the assignment of a given vertex being assigned. In various instances, however, this is not true and the assignments for initial vertices are not always reliable.

In various instances, during the first iteration through phase 220, when the first half of the vertices in an augmented graph model are processed, no information about the remaining vertices' community assignments may be known. That is, the greedy modularity maximization technique may take very limited information when processing most of vertices in the network. In various instances, this may generate different local optimums that are not globally optimal because global modularity would be greater for the model if the certain vertices were grouped in different communities. In following iterations, even when the community assignments of all of the vertices in the augmented graph model are known, these local optimums will not improve due to a “mutual effect.” In an illustrative example, assume that vertices v_{b} and v_{c} are processed after vertex vₐ, and that both are assigned into the same community with vₐ (thus vₐ, v_{b} and v_{c} are in the same community). In subsequent iterations, when vₐ's community assignment is reevaluated, the community assignments of vertices v_{b} and v_{c} will affect vertex vₐ's community reassignment by keeping it from re-assigning to other communities (even when so doing would result in an increased global modularity). This kind of effect is referred to herein as a “mutual effect.”

In various instances, this scenario happens frequently since the earlier the assignment of a vertex, the less information that can be used for that assignment. A single edge with a large weight can result in two vertices having locally optimal but not globally optimal assignments when the model does not have enough information. In a payment network, for example, one occasional transaction involving a large amount can result in the nodes for two merchants being grouped in the same locally optimal but not globally optimal community, and this less-than-optimal grouping can also affect further assignments of other vertices.

In FIGS. 4A-4B, the number on each vertex represents its order of processing. At step 400, each vertex is initialized to its own individual community. Then, according to the sequence of the order of processing, the community assignment of every vertex is compared to its neighbors' community assignments by modularity gain. At step 402, vertex v₁ is grouped with vertex v₀ into community 430. At step 404, vertex v₂ is also grouped into community 430. At step 406, vertex v₃ is grouped into community 432 with vertex v₇, even though vertex v₃ has neighbor vertices v₂, v₈ and v₁₀ in addition to v₇. At step 406, however, vertices v₈, v₉, and v₁₀ are in their individual communities because they have not been processed. In the ideal result, however, indicated by ground truth 418, vertices v₈, v₉, and v₁₀ are in community 430 with v₂ and v₃ according their connectivity. Thus, in step 406, v₃ should also be assigned to community 430 for its dense connections with v₂, v₈, v₉, and v₁₀. But the model does not have this information at step 406. At step 408, v₄ is grouped with v₅ into community 434. At step 410, v₆ is also grouped into community 434. At steps 412 and 414, v₈ and v₉ are, respectively, grouped into community 430. At step 416, v₁₀ is grouped into community 432 because of the influence of grouping v₃ and v₇ into community 432 at step 406. But, as discussed above, in the ground truth 418 there is no community 432, and therefore refinement of the grouping will improve the result as discussed below in reference to modularity refinement phase 230 in FIG. 2. Note that block 226 iterates back to block 222. After each iteration, the modularity will be compared with the value in the previous iteration. The learning algorithm converges once modularity increase stops in an iteration, and method 200 continues to phase 230.

In various embodiments, method 200 includes modularity refinement phase 230 in which the community assignments of various nodes are reevaluated. In various embodiments, modularity refinement phase 230 includes block 232. At block 232, computer system 100 performs modularity refinement to refine the community assignments from modularity maximization phase 220. In various embodiments, such modularity refinements include removing or minimizing the local optimums (that are not globally optimal) discussed herein by reassigning nodes to different subsets. During modularity refinement phase 230, computer system 100 reevaluates each attributed node according to the same sequence as used in phase 220 to determine whether any regrouping of the attributed nodes is warranted. During the reevaluating, the grouping of a given node is reevaluated without reference to the grouping of other attributed nodes that were previously grouped in the same subset, but which occur later in the sequence.

Completely getting rid of all of the local optimums that are not globally optimal means finding the optimum solution for a modularity maximization problem, which is np-hard and not practical in various embodiments. However, an effective greedy refinement can be performed to improve the result without expending as many computing resources. In such embodiments, the community assignments can be refined by giving each vertex a chance to reassign its community after all of the vertices have been assigned (e.g., after step 416 shown in FIG. 4B) with the mutual effect eliminated.

In refinement, all vertices' community assignments will be reevaluated in the same order from phase 220. When reevaluating a vertex vᵢ, vᵢ will be compared with three types of neighbors: (i) a neighbor that has the same community assignment as vᵢ, assigned before vᵢ's assignment, (ii) a neighbor that has same community assignment as vᵢ, assigned after vᵢ, and (iii) a neighbor that has a different community assignment from vᵢ.

During reevaluation of a given node vᵢ, the neighbors of that node that were assigned to the same community later in the sequence (i.e., used in phase 220) than vᵢ are temporarily masked. In such instances, the masked vertices are those whose community assignments are directly affected by the current vertex vᵢ in the greedy modularity maximization process. Additionally, in such instances, those vertices processed after vᵢ but have different community assignments from vᵢ are not masked. If vᵢ's assignment is changed to one of its neighbors, say vₙ's assignment, because that represented that largest modularity gain, then there are two possible cases: (1) if vₙ is a masked neighbor, then vᵢ keeps its original assignment, i.e., vᵢ's community assignment is unchanged during the re-evaluation, or (2) if vₙ is not a masked neighbor, then vᵢ will be re-assigned to vₙ's community.

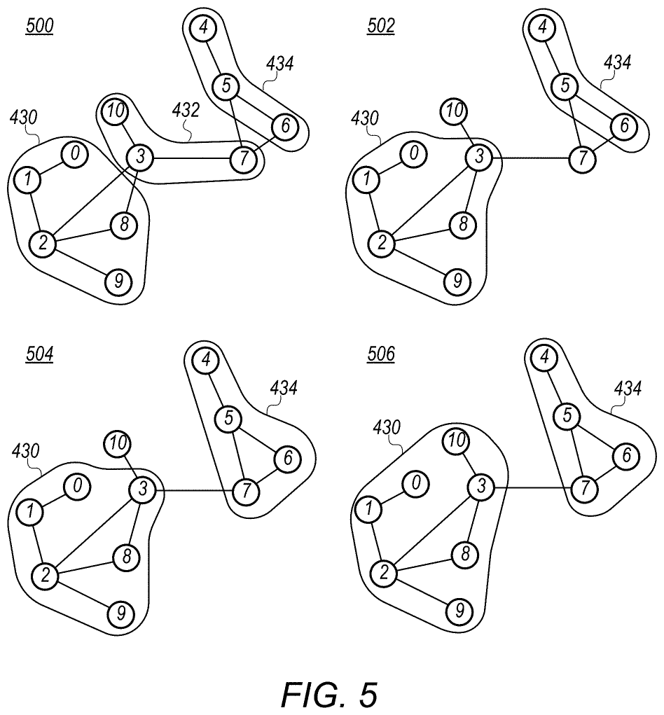

Referring now to FIG. 5, a series of pictures illustrating an exemplary process of nodes being regrouped into subsets in accordance with the disclosed embodiments is shown. In various embodiments, the nodes are regrouped into communities using the modularity refinement techniques discussed herein in reference to modularity refinement phase 230 in FIG. 2. Referring back to FIG. 4B, in ground truth 418, vertices v₃ and v₁₀ belong to community 430, while vertex v₇ belongs to community 434. Referring again to FIG. 5, at step 500, the community assignments of all vertices from modularity maximization phase 220 are shown with vertex v₃ is assigned to a community with vertices v₇ and v₁₀. In step 502, when reevaluating vertex v₃, vertices v₇ and v₁₀ will be temporarily masked to individual communities, because they originally were processed after v₃. After the masking, the mutual effects between vertices v₃, v₇, and v₁₀ are eliminated. After re-evaluation, v₃ is reassigned to community 430 because joining into it produces larger modularity gain than joining either temporary community of v₇ or of v₁₀. Accordingly, the relationship between either v₇ or v₁₀ to v₃ is not strong enough to continue keeping v₃ in their communities once the mutual effect is eliminated. At step 504, v₇ is reassigned to community 434. Then, at step 506, v₁₀ is reassigned to community 430. Accordingly, the result of modularity refinement phase 230 shown in FIG. 5 more closely matches ground truth 418 shown in FIG. 4B than the result of modularity maximization phase 220. Thus, in modularity refinement phase 230, the mutual effect is eliminated but other information in the graph is retained. Accordingly, if a vertex is reassigned to one of those masked neighbors' community again, it indicates these vertices have sufficiently strong relationships to group them in the same community.

In various embodiment, the techniques described herein are used to generate an augmented graph model of a network of transactions between buyers and sellers made over a payment service. In such embodiments, the augmented graph includes nodes representing buyers, nodes representing sellers, and center point nodes representing attribute clusters associated with various sellers, as discussed herein. In such embodiments, nodes representing buyers are connected to nodes representing sellers by edges to represent transactions, and center point nodes for the attributed cluster are connected to buyer nodes grouped in the respective attribute cluster by attribute edges. Using the techniques disclosed herein, the augmented graph model can be analyzed to identify one or more communities from among the buyers using the topological information from the augmented graph model as well as the attribute information represented in the model using the center point nodes and attribute edges. In a simplified example, and referring again to FIGS. 4A and 4B, using the techniques disclosed herein, nodes representing various sellers are grouped into communities 430, 432, and 434. As discussed herein, however, grouping nodes v₃, v₇, and v₁₀ together is locally optimal based on incomplete information during phase 220 (of FIG. 2), but this grouping is not the globally optimal result. As discussed herein, this may be because particularly large transactions involving v₃ and v₇ initially suggest that these two nodes should be grouped together, but additional analysis would show that this result is not globally optimal but for the mutual effect between the two nodes. Referring now to FIG. 5, however, the grouping is refined in phase 230 (of FIG. 2) such that when the mutual effect is removed, v₃ and v₁₀ are grouped in community 430 and v₇ is grouped into community 434. Then, in various embodiments, these community groupings can be used to the benefit of the payment service (e.g., by identifying security risks associated with a certain community, by identifying transactions that might involve contraband, etc.) as discussed herein.

### Complexities in Attribute Information

In various embodiments, attribute values set 112 includes information stored in various different data types. For example, a merchant's business region is a categorical value while its payment volume is numerical. Clustering on attributes with mixed types is challenging, and is incompatible with various clustering techniques.

In addition to mixed data types, attribute values set 112 may include additional special data types that are unable to be processed directly by traditional data processing algorithms in various instance. One such special data type is the “many-value categorical attribute,” and another is the “multi-value categorical attribute.” As used herein, “many-value categorical attributes” are attributes that contain a large cardinality of values. For example, the value of a “country code” attribute may contain more than one hundred country codes. Using hot encoding on this type of attribute leads to sparse latent dimensions which decreases clustering performance. As used herein, “multi-value categorical attributes” refer to attributes that contain multiton values (as opposed to singleton values). One example is an attribute “product bundle”. Each value of this attributed is a set of singleton values such as product A, product B. In various embodiments, these special data types are specially handled before they are used for clustering.

In various embodiments, however, the disclosed techniques are flexible enough to adapt different methods for attribute clustering. For example, in various embodiments a k-prototype algorithm is used to cluster attributes and construct the augmented graph. In such embodiments, k-prototype extends the k-means clustering algorithm and is efficient for clustering large data sets with mixed attribute types. The k-prototype algorithm clusters data against k prototypes instead of k means. Each prototype is represented by a vector which is a combination of numerical attributes and categorical attributes. In each iteration, k-prototype updates numerical attributes by their means while updating categorical attributes by their modes. In k-prototype, the distance between a vertex vᵢ and a prototype vₚ is defined by Equation 9:

d(vᵢ,vₚ)=Σⱼ₌₁^{m}^{ᵣ}(vᵢⱼ^{r}−vₚⱼ^{r})²+γΣⱼ₌₁^{m}^{_{c}}δ(vᵢⱼ^{c},vₚⱼ^{c}) Equation 9:

In Equation 9, mᵣ is the number of numerical attributes, vᵢⱼ^{r} and vₚⱼ^{r} are values of a numeric attribute of vᵢ and vₚ, respectively. m_{c} is the number of categorical attributes and vᵢⱼ^{c} and vₚⱼ^{c} are values of a categorical attribute. γ is a weight balancing the two types of attributes: δ(vᵢⱼ^{c}, vₚⱼ^{c})=0 if vᵢⱼ^{c}=vₚⱼ^{c} and δ(vᵢⱼ^{c}, vₚⱼ^{c})=1 otherwise

Because, however, in various embodiments the set of information specifying attribute information is complex in various ways, attribute values are normalized in various embodiments to retain categorical value distribution and to handle multi-value and many-value categorical attributes. In such embodiments, (a) numerical attributes are normalized by z-score normalization; (b) categorical attributes (excluding multi-value and many-value attributes), are encoded by one hot encoder and normalized by z-score normalization; and/or (c) for multi-value and many-value categorical attributes, each singleton value is normalized by z-score normalization and stored as a (categorical value, z-score) pair and each multi-value attribute is stored as a set of key-value pairs.

The distance between a vertex vᵢ and a prototype vₚ is redefined as Equation 10:

$$d ( {v}_{i} , {v}_{p} ) = {\sum }_{j = 1}^{{m}_{r}} ‖ ( {v}_{i j}^{\hat{r}} - {v}_{p j}^{\hat{r}} ) ‖ + {\sum }_{j = 1}^{{m}_{c}} ‖ ( {v}_{i j}^{\hat{c}} - {v}_{p j}^{\hat{c}} ) ‖ δ ( {v}_{i j}^{c} , {v}_{p j}^{c} ) + {\sum }_{j = 1}^{{m}_{u}} J ( {v}_{i}^{\hat{u}} , {v}_{p}^{\hat{u}} ) + {\sum }_{j = 1}^{{m}_{a}} ‖ ( {v}_{i j}^{\hat{a}} - {v}_{p j}^{\hat{a}} ) ‖ δ ( {v}_{ij}^{a} , {v}_{p j}^{a} ) \qquad Equation 10$$

In Equation 10, denotes normalized values, v^{u} is a value of a multi-value attribute and v^{a} represents a value of many-value attribute. With respect to the original distance, the difference of normalized values between two categorical values to represent their distance is used, instead of 1.

For multi-value attributes, each value is a set of key-value pairs. The distance between these vertexes is calculated using weighted Jaccard distance J in Equation 11.

$$J ( {\hat{v}}_{i} , {\hat{v}}_{p} ) = 1 - \frac{{\sum }_{x ∈ {\hat{v}}_{i} ⋂ {\hat{v}}_{p}} w ( x )}{{\sum }_{y ∈ {\hat{v}}_{i} ⋂ {\hat{v}}_{p}} w ( y )} \qquad Equation 11$$

Here w(x) is the normalized value of x. The weighted Jaccard distance J, with values in the range of [0,1], measures the dissimilarity between two multi-value attributes.

In various embodiments, the original k-prototype algorithm updates a categorical attribute of a prototype in two steps: (i) calculate the frequency for all categories, and (ii) assign the prototype the category with highest frequency.

This updating scheme can be directly extended to many-value attributes and multi-value attributes. For multi-value attribute, the value of a prototype is a set of singleton values. For example, given 4 attributes, each has its 4, 5, 4, 3 singleton values respectively, listed in a column as shown here:

$$[ \begin{matrix}{c}_{1 , 1} & {c}_{2 , 1} & {c}_{3 , 1} & {c}_{4 , 1} \\ {c}_{1 , 2} & {c}_{2 , 2} & {c}_{3 , 2} & {c}_{4 , 2} \\ {c}_{1 , 3} & {c}_{2 , 3} & {c}_{3 , 3} & {c}_{4 , 3} \\ {c}_{1 , 4} & {c}_{2 , 4} & {c}_{3 , 4} & \\ & {c}_{2 , 5} & & \end{matrix} ]$$

If k is 3, 3 prototypes with 4 multi-value attributes can be assigned as:

p1={{c1,1, c1,3}, {c2,1, c2,2}, {c3,2}, {c4,1, c4,3}},

p2={{c1,2}, {c2,3, c2,4}, {c3,2}, {c4,2}},

p3={{c1,4}, {c2,2}, {c3,3, c3,4}, {c4,3}

In various embodiments, a singleton value is considered frequent if it is shared by majority vertices in a cluster. Based on this intuition, multi-value attribute can be updated in two steps: (i) calculate frequencies for all singleton values of one multi-value attribute, and (ii) assign to the prototype the set of singleton values where each value is shared by more than half vertices in the cluster. In other words, when a value is shared by more than half of vertices in a cluster, it will be updated to the prototype because it is considered a common feature to that cluster.

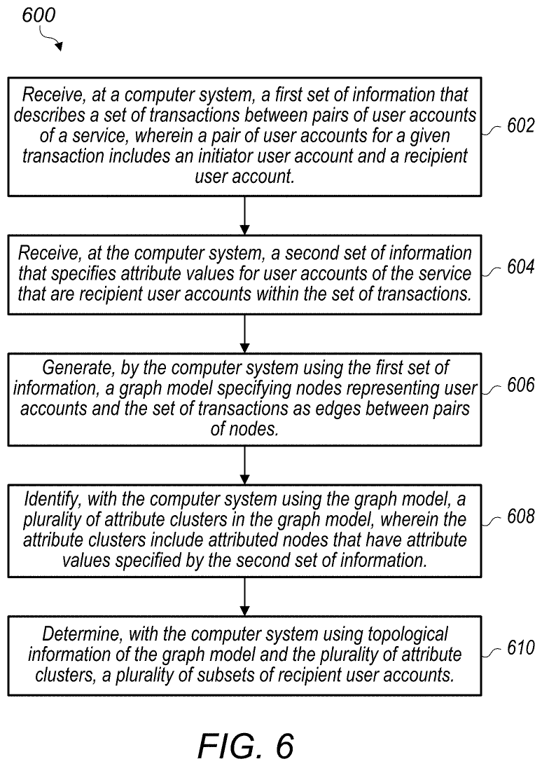

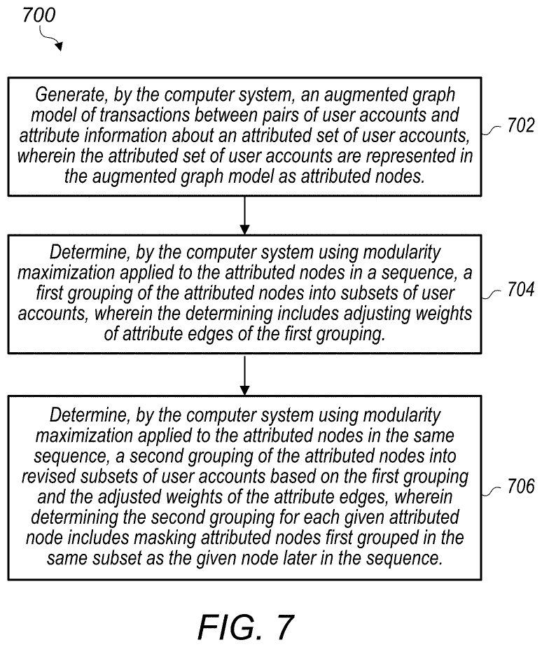

FIGS. 6 and 7 illustrate various flowcharts representing various disclosed methods implemented with computer system 100. Referring now to FIG. 6, a flowchart depicting a user account subset determining method 600 is depicted. In the embodiment shown in FIG. 6, the various actions associated with method 600 are implemented by computer system 100. At block 602, computer system 100 receives a first set of information set (e.g., transaction set 110) that describes a set of transactions between pairs of user accounts of a service. A pair of user accounts for a given transaction includes an initiator user account and a recipient user account. At block 604, computer system 100 receives a second set of information (e.g., attribute values set 112) that specifies attribute values for user accounts of the service that are recipient user accounts within the set of transactions. At block 606, computer system 100 generates a graph model specifying nodes representing user accounts and the set of transactions as edges between pairs of nodes as discussed herein in connection to phase 210 of FIG. 2. At block 608, computer system 100 identifies, using the graph model, a plurality of attribute clusters 124 in the graph model as discussed herein in connection to phase 210 of FIG. 2 and FIG. 3. The attribute clusters include attributed nodes that have attribute values specified by the second set of information. At block 610, computer system 100 determines, using topological information of the graph model and the plurality of attribute clusters, a plurality of subsets of recipient user accounts as discussed herein in connection to phases 220 and 230 of FIG. 2 and the various steps of FIGS. 4A, 4B, and 5.

Referring now to FIG. 7, a flowchart depicting a user account subset determining method 700 is depicted. In the embodiment shown in FIG. 7, the various actions associated with method 700 are implemented by computer system 100. At block 702, computer system 100 generates an augmented graph model of transactions between pairs of user accounts and attribute information about an attributed set of user accounts as discussed herein in connection to phase 210 of FIG. 2 and FIG. 3. The attributed set of user accounts are represented in the augmented graph model as attributed nodes. At block 704, computer system 100 determines, using modularity maximization applied to the attributed nodes in a sequence, a first grouping of the attributed nodes into subsets of user accounts as discussed herein in connection to phase 220 of FIG. 2 and the various steps of FIGS. 4A and 4B. This determining includes adjusting weights of attribute edges of the first grouping. At block 706, computer system 100 determines, modularity maximization applied to the attributed nodes in the same sequence, a second grouping of the attributed nodes into revised subsets of user accounts based on the first grouping and the adjusted weights of the attribute edges as discussed herein in connection to phase 230 of FIG. 2 and the various steps of FIG. 5. This determining of the second grouping for each given attributed node includes masking attributed nodes first grouped in the same subset as the given node later in the sequence.

Incrementally Adding Transactions to an Augmented Graph Model Using inc-AGGMMR

In terms of usage of computational resources and time, a bottleneck for adding additional nodes to the AGGMMR graph comes from clustering the additional nodes into attribute clusters and the iterative weight learning for the attribute edges. The inc-AGGMMR techniques described here present an alternative way to assign a vertex to its attribute cluster and approximate the weight on its attribute edge at a lower cost. In particular, the inventor observed that that the weight on attribute edge after weight learning is only related to its initial weight and the contribution score of the attribute cluster to which that vertex belongs.

Referring now to FIG. 8, a flowchart depicting an embodiment of an inc-AGGMMR method 800 is shown. In the embodiment shown in FIG. 8, the various actions associated with method 800 are implemented by computer system 100. In various embodiments, the inc-AGGMMR framework shown in method 800 is designed to incrementally add representations of additional transactions 140 and additional attribute values 142 to a model generated using the AGGMMR framework described above. As with the AGGMMR framework, once the additional transaction(s) 140 and additional attribute value(s) 142 are added to the model, the inc-AGGMMR framework is designed to partition an attributed graph based on its attributes and topological information, through a greedy modularity maximization model. In various embodiments, method 800 includes four phases: a generation of the augmented graph model and grouping of user accounts phase 810, an insert additional nodes phase 820, an incremental assignment and weight adjustment phase 830, and another modularity refinement phase 840.

In various embodiments, generation of the augmented graph model and grouping phase 810 includes the various actions discussed above in reference to method 200 in FIG. 2. As discussed above, as a result of method 200, an augmented graph model is generated of (a) a set of transactions 110 previously performed between respective pairs of initiator user accounts of a service and recipient user accounts of a service and (b) attribute values 112 for a subset of the recipient user accounts. The augmented graph model includes cluster nodes that (a) have been inserted into attribute clusters identified within the augmented graph model and (b) are connected by weighted attribute edges to attributed nodes of the augmented graph model. As discussed above, attributed nodes are nodes that correspond to recipient user accounts having attribute values.

In various embodiments, generation of the augmented graph model and grouping of user accounts phase 810 proceeds according to Equations 1 through 8 discussed above. The augmented graph model generated in phase 810 includes nodes representing user accounts, transaction edges between pairs of user accounts representing transactions between the user accounts, and cluster nodes connected to attributed nodes by attribute edges. As discussed above, these attribute edges are initialized (Equation 2) and then trained using one or more modularity algorithms (Equations 3-8). Once the attribute edges have been trained, in various embodiments a modularity refinement phase 230 is performed to determine whether to regroup one or more nodes as discussed above. In various embodiments, the groupings of user accounts generated by the AGGMMR framework may be stored in a separate data structure from the augmented graph model (e.g., a table) that may be separately accessed such that after the groupings have been made, applications of the groupings (e.g., applying different risk policies) may be accomplished without accessing the entire augmented graph model. Thus, as a result of graph model and grouping phase 810, attribute edges of an augmented graph model have been generated and trained and the augmented graph model has been used to identify groups of user accounts according to the AGGMMR framework described above.

After computer system 100 receives the indications of one or more additional transactions 140 and additional attribute values 142, the augmented graph model is updated to include the additional information according to the inc-AGGMMR framework described below in reference to phases 820, 830, and 840. In various instances, the additional transaction 140 will be between a pair of user accounts of the service, either or both of which are not represented in the augmented graph model generated at phase 810. In various instances, the additional transaction 140 involves a recipient user account that is not represented in the model and for which additional attribute values 142 are also received. Thus, in various instances, the additional recipient user account and the attribute values for the additional recipient user account are represented in the augmented graph model using the inc-AGGMMR framework.

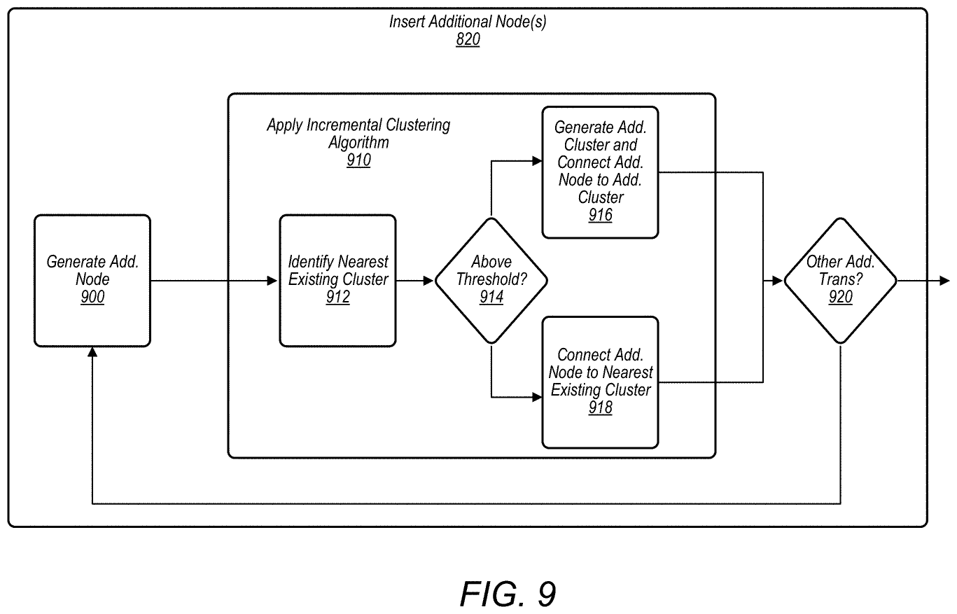

At the insert additional node(s) phase 820, the augmented graph model is modified by representing the additional recipient user account as an additional node in the augmented graph model, determining whether to cluster the additional node with one of the attribute clusters, and based on the determining, connecting the additional node to a particular cluster node of a particular attribute cluster with an additional attribute edge. The various operations of phase 820 are discussed in further detail in reference to FIG. 9.

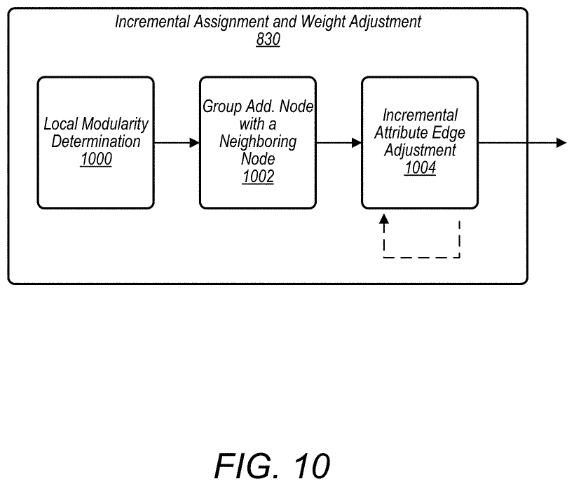

At the incremental assignment and weight adjustment phase 830, the node representing the additional recipient user account is grouped with one or more neighboring nodes in the augmented graph model and the attribute weights are adjusted based on how the grouping affects the modularity of the augmented graph. As discussed below, in various embodiments, phase 830 employs a determination of local modularity maximization to determine into which group of neighboring nodes to group the additional node. The various operations of phase 830 are discussed in further detail in reference to FIG. 10.

At modularity refinement phase 840, the community assignments of various nodes are reevaluated in the same manner as modularity refinement phase 230 of method 200 discussed above in reference to the AGGMMR framework. Modularity refinement phase 840 includes block 232, which proceeds in the same manner as discussed above to refine the community assignments as a result of changes to the augmented graph resulting from adding and clustering the additional nodes and the resulting adjustments to attribute weights. In various embodiments, such modularity refinements include removing or minimizing the local optimums (that are not globally optimal) discussed herein by reassigning nodes to different group. During modularity refinement phase 840, computer system 100 reevaluates each node according to the same sequence as the nodes were added to the augmented graph to determine whether any regrouping of the nodes is warranted. As discussed above, during modularity refinement, nodes may be regrouped because doing so will increase global modularity across the augmented graph model. During the reevaluating, the grouping of a given node is reevaluated without reference to the grouping of other nodes (both attributed nodes and nodes without attributes) that were previously grouped into the same subset, but which occur later in the sequence.

Thus, in various embodiments, using the inc-AGGMMR framework, computer system 100 is operable to add additional nodes representing user accounts involved in additional transactions 140 to the augmented graph model without redoing the attribute clustering and weight learning performed at phase 810. As discussed above, after the augmented graph model is generated, at least two modularity algorithms (e.g., modularity maximization at phase 220 and modularity refinement at phase 230 discussed above) are used to group nodes of the augmented graph that represent user accounts, thereby identifying “communities” of user accounts. As discussed below, in applying the inc-AGGMMR framework to add and group additional nodes, additional modularity algorithms may be applied (e.g., local modularity maximization at phase 830 and modularity refinement at phase 840), which causes the weights of the various attribute edges to be trained to reflect changes to the augmented graph model as additional nodes are added. As with modularity maximization at phase 220 and modularity refinement at 230, after phases 830 and 840, various attribute edge weights of the augmented graph model will be updated to reflect the effect of additional nodes on the augmented graph model, but at a lower computational cost than redoing all of the initial learning performed during phase 810.

FIG. 9 is a flowchart depicting insert additional node(s) phase 820 in additional detail. At block 900, an additional node is generated for the additional recipient user account of transaction 140 and added to the augmented graph model. At block 910, an incremental clustering algorithm is applied to the additional node to determine an attribute cluster for the additional node. In various embodiments, incrementally clustering new vertices to attribute clusters can be implemented by a typical incremental clustering algorithm with a threshold. At block 920, computer system 100 determines to loop through insert additional node(s) phase 820 again based on whether there are any more additional transactions 140 and additional attribute values 142 to add to the augmented graph model.

In various embodiments, applying the incremental clustering algorithm includes (a) determining the distance (e.g., the Euclidian distance) between the additional node generated at block 900 and one or more of the nearest existing attribute clusters and (b) identifying the nearest existing attribute cluster (block 912). In various embodiments, the distance can be determined based on the distance between the additional node and the cluster node for the various attribute clusters. In other embodiments, however, the distance may be calculated based on the distance between the additional node and the center point of the various clusters (e.g., if the cluster node is not disposed the center point).

At block 914, the distance between additional node and the nearest existing attribute cluster is compared to a threshold value. In various embodiments, the threshold value may be set based on the greatest distance, prior to receiving the indications of additional transactions 140 and additional attribute values 142, between any particular attribute node and a respective cluster node to which the particular attributed node is connected by a respective weighted attribute edge. In such embodiments, the threshold may be set as the greatest distance or as some factor of the greatest distance (e.g., 125% of the greatest distance).

If the distance between the additional node and the nearest existing attribute cluster is above the threshold value, a new attribute cluster is generated for the additional node generated to represent an additional recipient user account and the additional node is connected to the new attribute cluster with an attribute edge (block 916). In various embodiments, the additional node is connected by the attribute edge to a cluster node generated for the new attribute cluster. In various embodiments, the weight of the attribute edge is initialized using a weighted degree of the additional node in the augmented graph model using Equation 2 discussed above. Since no information about the new attribute cluster is known initially (similar to when attribute clusters are initially generated during the AGGMMR framework) at the current stage, only topological information is used to initialize the weight of the new attribute edge. The weight will be adjusted incrementally in phase 830 discussed in reference to FIG. 10. In such instances, the new attribute cluster and attribute edge represents the additional attribute values 142 for the additional recipient user account in the augmented graph model.

If the distance between the additional node and the nearest existing attribute cluster is below or equal to the threshold value, the additional node is clustered with the nearest existing attribute cluster and is connected to the nearest existing attribute cluster with an attribute edge (block 918). In various embodiments, the additional node is connected by the attribute edge to the cluster node of the nearest existing attribute cluster. In various embodiments, because the attribute edges of every attributed node connected to a particular attribute cluster has the same weight, the attribute edge for the additional node is initialized with this same weight. Thus, whether the additional node is connected to a newly-generated attribute cluster or an existing attribute cluster, the attribute relationships (i.e., how similar or dissimilar a particular attributed node is from other attributed nodes) of the new nodes are retained on the augmented graph model by those new attribute edges.

FIG. 10, is a flowchart depicting incremental assignment and weight adjustment phase 830 in additional detail. As discussed above, in the augmented graph model, both attributes and topological relationships are represented by edges. As with weight learning with modularity maximization phase 220 discussed in reference to FIG. 2, here the Louvain modularity maximization model is used to determine a grouping for the additional nodes. At block 1000, the local modularity that would result from grouping the additional node with one of its neighbor's groups is determined. As used herein, a “neighboring node” is a node to which the additional node is connected by a transaction edge (e.g., the additional node and the neighboring node are a transaction pair in a transaction in transaction set 110 or in an additional transaction 140). Thus, an additional node representing a first additional user account is grouped in the same group as one of the other users accounts with which the first additional user account has transacted as an initiator or as a recipient of a transaction. In various embodiments, the additional node is grouped with the neighboring node that maximizes local modularity (i.e., the modularity that results from grouping the additional node with one of its neighbors). In various embodiments, local modularity for an additional node (vertex vᵢ) is assigned to one of its neighboring node's groups by maximizing the modularity gain though Equation 12:

$$Δ Q = [ \frac{{\sum }_{i n} + 2 {k}_{i , i n}}{2 m} - {( \frac{{\sum }_{t o t} + {k}_{i}}{2 m} )}^{2} ] - [ \frac{{\sum }_{i n}}{2 m} - {( \frac{{\sum }_{t o t}}{2 m} )}^{2} - {( \frac{{k}_{i}}{2 m} )}^{2} ] \qquad Equation 12$$

In Equation 12, Σᵢₙ is the total weight within the group of user accounts that vᵢ is going to join. Σₜₒₜ is the total weight to all vertices within that group of user accounts. kᵢ is the weighted degree of the vᵢ and k_{i,in} is the sum of weights that vᵢ connects to the other vertices within that group of user accounts.

After determining into which groups of user accounts to group the additional node(s), weights of attributed edges are adjusted for attribute clusters according to their contributions (block 1004). In AGGMMR, the weight of wᵢ for an attribute edge is learned from the iterative algorithm showed in Equations 5-7 above. The process of weight learning after n iterations is shown below in Equations 13 and 14:

$$\begin{matrix}{w}_{i}^{t + 1} = \frac{1}{2} ( {w}_{i}^{t} + \frac{{Θ}_{a}}{\sum θ} \frac{W}{\vert {V}_{a} \vert} ) = \frac{1}{2} ( \frac{1}{2} ( … ( \frac{1}{2} ( {w}_{i}^{1} + \frac{{Θ}_{a 1}}{\sum Θ} \frac{W}{\vert {V}_{a} \vert} ) + \frac{{Θ}_{a 2}}{\sum Θ} \frac{W}{\vert {V}_{a} \vert} ) … ) + \frac{{Θ}_{a n}}{\sum Θ} \frac{W}{\vert {V}_{a} \vert} ) = \frac{1}{{2}^{n}} {w}_{i}^{1} + \frac{{Θ}_{a 1}}{{2}^{n - 1} \sum θ} \frac{W}{\vert {V}_{a} \vert} + \frac{{Θ}_{a 2}}{{2}^{n - 2} \sum θ} \frac{W}{\vert {V}_{a} \vert} + … + \frac{{Θ}_{a n}}{{2}^{1} \sum Θ} \frac{W}{\vert {V}_{a} \vert} = \frac{1}{{2}^{n}} {w}_{i}^{1} + Δ & Equation 13 \\ Δ = \frac{{Θ}_{a 1}}{{2}^{n - 1} \sum θ} \frac{W}{\vert {V}_{a} \vert} + \frac{{Θ}_{a 2}}{{2}^{n - 2} \sum θ} \frac{W}{\vert {V}_{a} \vert} + … + \frac{{Θ}_{a n}}{{2}^{1} \sum θ} \frac{W}{\vert {V}_{a} \vert} = ( \frac{{Θ}_{a 1}}{{2}^{n - 1} \sum Θ} + \frac{{Θ}_{a 2}}{{2}^{n - 2} \sum Θ} + … + \frac{{Θ}_{a n}}{{2}^{1} \sum Θ} ) \frac{W}{\vert {V}_{a} \vert} & Equation 4\end{matrix}$$

Observe that the weight is only affected by the contribution score Θ and an initial weight wᵢ^{t}. The change of weight Δ is shared by all nodes connected to the same attribute cluster. When n gets larger, the impact of initial weight wᵢ^{t} gets smaller. The final weight is proportional to the contribution score of each attribute center. Thus, the weight update on attribute edge can be approximated by Equation 15:

$${w}_{i}^{t + 1} = \frac{{Θ}_{a}}{\sum θ} \times \frac{W}{\vert {V}_{a} \vert} W = \sum {w}^{t} \qquad Equation 15$$

This approximation offers two advantages. First, the contribution of each attribute cluster is well captured. The goal of weight learning is to adjust the weight (i.e., contribution) among different attribute centers to a detected community. The weight is adjusted according to the contribution of each attribute cluster towards the final objective. This new weight adjustment scheme well fits the objective of weight learning. Second, the approximation enables incremental updates. The weight of an attribute edge can be immediately adjusted by recomputing the contribution score of each attribute center after new nodes are added.

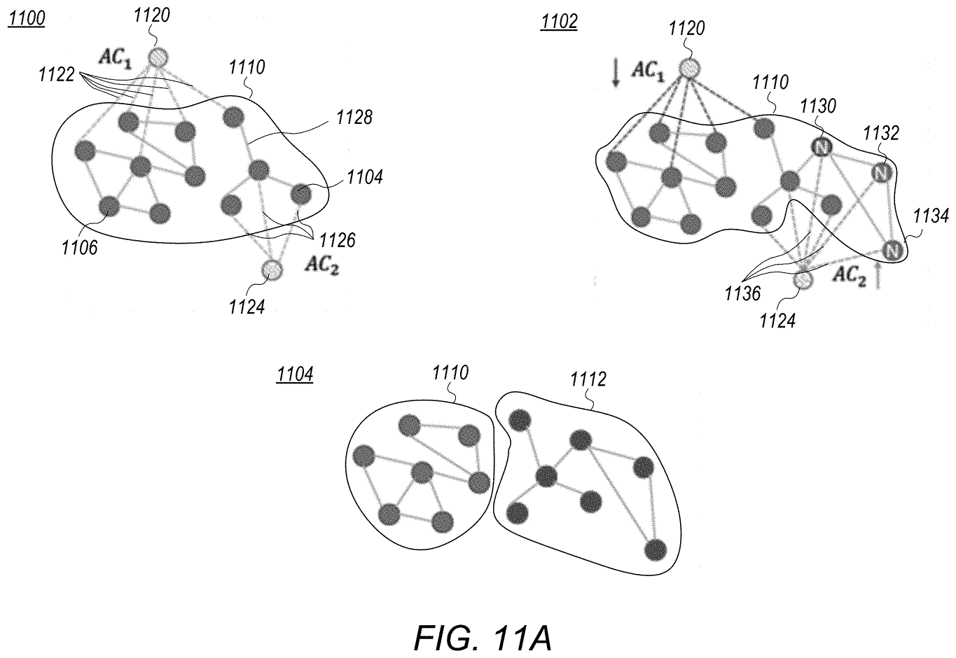

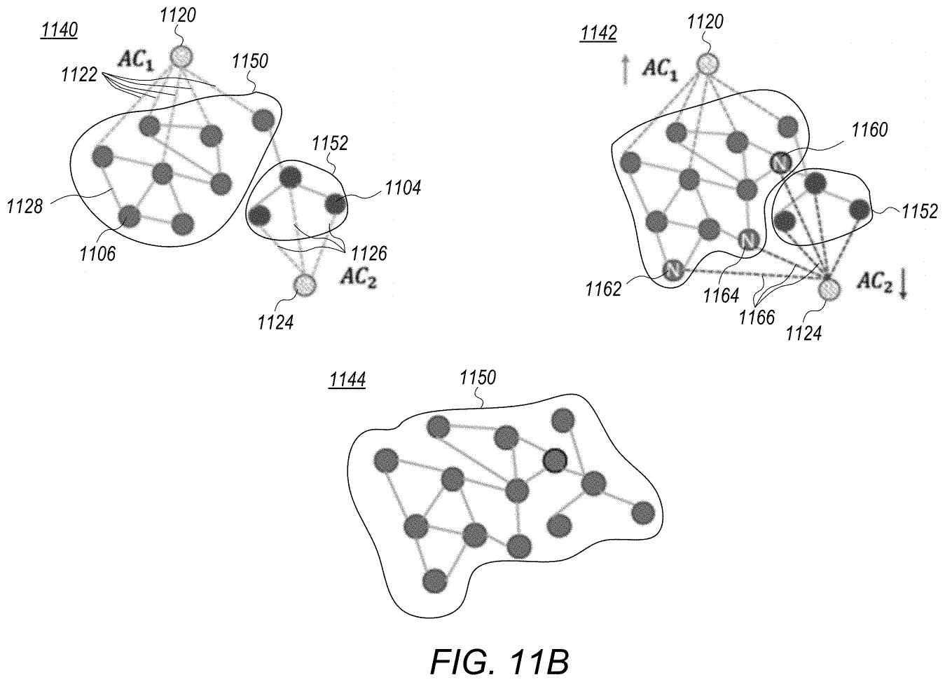

FIGS. 11A and 11B illustrates two examples of how incremental weight learning adjusts the weights along with the evolving of the graph. In the illustrations, cluster nodes 1120 and 1124 for attribute clusters AC1 and AC2 as shown as light-colored dots, and the attribute edges 1122 and 1126 are shown as dotted lines connecting attributed nodes 1104 (shown as darker dots) to a cluster node 1120 or 1124. Additionally, a plurality of non-attributed nodes 1106 (also shown as darker dots) are also shown in FIGS. 11A and 11B, and these non-attributed nodes 1106 are not connected to a cluster node 1120, 1124. Various nodes (attributed and non-attributed) are connected by transaction edges 1128 shown as solid lines. Nodes that are grouped together are encircled. For example, the nodes in FIG. 11A are initially grouped together in a first group 1110 and the addition of additional nodes 1130, 1132, and 1134 results in the nodes being regrouped in first group 1110 and a second group 1112.

Referring now to FIG. 11A, at 1100, the attributed nodes that belong to AC1 and AC2 are all assigned to first group 1110 prior to nodes for additional transactions 140 being added. At 1102, three additional nodes 1130, 1132, and 1134 (labeled letter N) are added to the augmented graph model and are clustered with AC2. Accordingly, additional attribute edges 1136 connect cluster node 1124 to the three additional nodes 1130, 1132, and 1134. These additional nodes 1130, 1132, and 1134 bring new information to the augmented graph model and the incremental weight learning algorithm is able to adjust the weights of attribute edges accordingly. As these three additional nodes 1130, 1132, and 1134 have strong attribute relationships among nodes in attribute cluster AC2, all of them are assigned to the same first group 1110 by modularity maximization. In other words, the attribute relationships in AC2 are strong and provide a positive contribution to the community detection task. Thus, the weights of attribute edges to AC2 are increased, while the weights of attribute edges to AC1 are decreased. At 1104, after re-evaluating the group assignments with the updated attribute edges 1122, 1126, inc-AGGMMR is usable to detect two separated groups (first group 1110 and second group 1112) for a larger modularity gain. It will be understood that the result is consistent with a non-incremental community detection process.

Referring now to FIG. 11B, at 1140, nodes are assigned to two groups 1150 and 1152 1110 prior to nodes for additional transactions 140 being added. At 1142, three additional nodes 1160, 1162, and 1164 (labeled letter N) are added to the augmented graph model and are clustered with AC2. Accordingly, additional attribute edges 1166 connect cluster node 1124 to the three additional nodes 1160, 1162, and 1164. These new nodes are densely connected with nodes in both groups 1150 and 1152 while they have attribute relationships with AC2. After considering both attribute and topological relationships, these new nodes are assigned to a first group 1150 by local modularity maximization, which is a different group from second group 1152 to which the other nodes belonging to AC2 have been assigned. As the nodes belong to AC2 are now distributed in two different groups, it suggests that the attribute relationships in AC2 are no longer consistent with the community detection objective. Those attribute relationships now become weaker; thus, the weights of attribute edges 1126 to AC2 are decreased while the weights of attribute edges 1122 to AC1 are increased. At 1144, after re-evaluating the community assignments with the updated attribute edges 1122, 1126, inc-AGGMMR detects a united group 1150 for a larger modularity gain. It will be understood that the result is again consistent with a non-incremental community detection process.

Thus, as a result of adding additional nodes to an augmented graph, various results may occur based on (a) how many additional nodes are added, (b) the topological relationship of the additional nodes, and/or (c) to which attribute clusters the additional nodes are assigned. In some instances, some nodes (previously existing nodes and/or additional nodes) may be regrouped from a first group to a second group (see FIG. 11A), merging nodes into a unified group (see FIG. 11B), creating a new group (see FIG. 11A again).

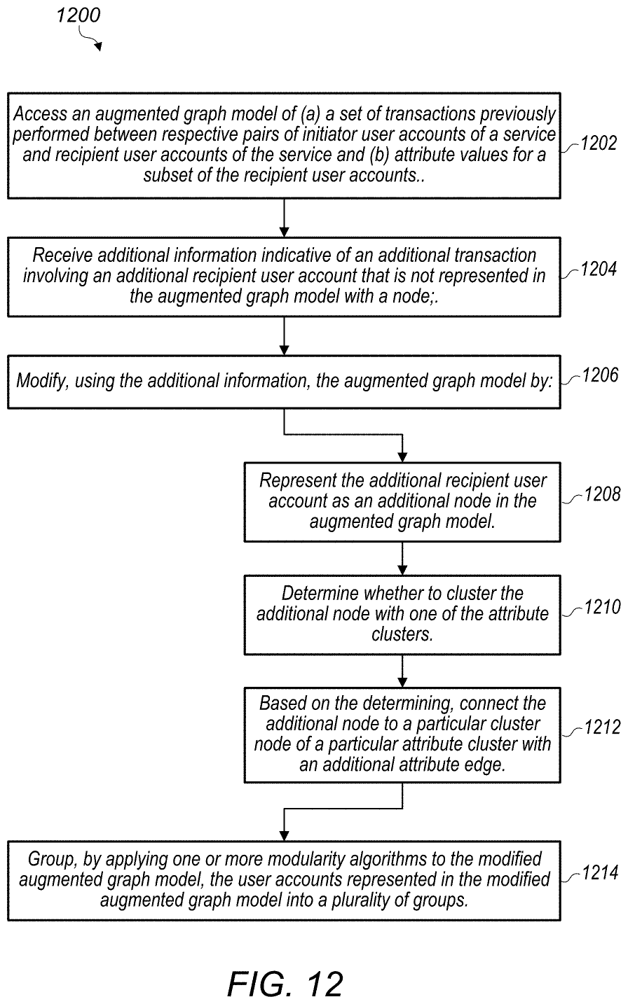

Referring now to FIG. 12, a flowchart depicting an incremental node addition method 1300 is depicted. In the embodiment shown in FIG. 12, the various actions associated with method 1200 are implemented by computer system 100. At block 1202, computer system 100 accesses an augmented graph model of (a) a set of transactions 110 previously performed between respective pairs of initiator user accounts of a service and recipient user accounts of the service and (b) attribute values 112 for a subset of the recipient user accounts. As discussed herein, the augmented graph model includes cluster nodes (e.g., cluster nodes 1120 and 1124) that (a) have been inserted into attribute clusters identified within the augmented graph model and (b) are connected by weighted attribute edges (e.g., attribute edges 1122 and 1126) to attributed nodes (e.g., attributed nodes 1104) of the augmented graph model, wherein the attributed nodes are nodes that correspond to recipient user accounts having attribute values 112. As discussed above, the augmented graph model may be generated according to Equations 1-8 and include indications of groupings of user accounts generated by applying one or more modularity algorithms to the augmented graph model such that weighted attribute edges of the augmented graph model are trained based on the groupings of user accounts.

At block 1204, computer system 100 receives additional information indicative of an additional transaction 140 involving an additional recipient user account that is not represented in the augmented graph model with a node. In various embodiments, the additional information includes additional attribute values 142. At block 1206, computer system 100 uses the additional information to modify the augmented graph model by: representing the additional recipient user account as an additional node in the augmented graph model (block 1208), determining whether to cluster the additional node with one of the attribute clusters (block 1210), and based on the determining, connecting the additional node to a particular cluster node of a particular attribute cluster with an additional attribute edge (block 1212). In various embodiments, the determining is based on a threshold distance between the additional node and one or more cluster nodes such that (a) if the additional node is within a threshold distance of one or more cluster nodes, the additional node is connected to the nearest cluster node with an additional weighted attribute edge, and (b) if the additional node is outside of a threshold distance from any cluster nodes, an additional cluster node is inserted into the augmented graph model and connected to the additional node with an additional weighted attribute edge. As discussed herein, in some embodiments, multiple additional nodes are added to the augmented graph model before method 1200 proceeds. At block 1214, computer system 100 groups, by applying one or more modularity algorithms to the modified augmented graph model, the user accounts represented in the augmented graph model into a plurality of groups (e.g., assigning additional nodes to existing or new groups and/or reassigning preexisting nodes to different groups).

### Exemplary Computer System

Turning now to FIG. 14, a block diagram of an exemplary computer system 1400, which may implement the various components of computer system 100 is depicted. Computer system 1400 includes a processor subsystem 1480 that is coupled to a system memory 1420 and I/O interfaces(s) 1440 via an interconnect 1460 (e.g., a system bus). I/O interface(s) 1440 is coupled to one or more I/O devices 1450. Computer system 1400 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1400 is shown in FIG. 14 for convenience, system 1400 may also be implemented as two or more computer systems operating together.

Processor subsystem 1480 may include one or more processors or processing units. In various embodiments of computer system 1400, multiple instances of processor subsystem 1480 may be coupled to interconnect 1460. In various embodiments, processor subsystem 1480 (or each processor unit within 1480) may contain a cache or other form of on-board memory.

System memory 1420 is usable to store program instructions executable by processor subsystem 1480 to cause system 1400 perform various operations described herein. System memory 1420 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1400 is not limited to primary storage such as memory 1420. Rather, computer system 1400 may also include other forms of storage such as cache memory in processor subsystem 1480 and secondary storage on I/O Devices 1450 (e.g., a hard drive, storage array, etc.). In some embodiments, these other forms of storage may also store program instructions executable by processor subsystem 1480.

I/O interfaces 1440 may be any of various types of interfaces configured to couple to and communicate with other devices, according to various embodiments. In one embodiment, I/O interface 1440 is a bridge chip (e.g., Southbridge) from a front-side to one or more back-side buses. I/O interfaces 1440 may be coupled to one or more I/O devices 1450 via one or more corresponding buses or other interfaces. Examples of I/O devices 1450 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1400 is coupled to a network via a network interface device 1450 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
accessing, at a computer system, an augmented graph model of (a) a set of transactions previously performed between respective pairs of initiator user accounts of a service and recipient user accounts of the service and (b) attribute values for a subset of the recipient user accounts,
wherein the augmented graph model includes cluster nodes that:
(a) have been inserted into attribute clusters identified within the augmented graph model and
(b) are connected by weighted attribute edges to attributed nodes of the augmented graph model, wherein the attributed nodes are nodes that correspond to recipient user accounts having attribute values;
receiving, at the computer system, additional information indicative of an additional transaction involving an additional recipient user account that is not represented in the augmented graph model with a node;
modifying, by the computer system using the additional information, the augmented graph model by:
representing the additional recipient user account as an additional node in the augmented graph model,
determining whether to cluster the additional node with one of the attribute clusters, and
based on the determining, connecting the additional node to a particular cluster node of a particular attribute cluster with an additional attribute edge; and
grouping, with the computer system by applying one or more modularity algorithms to the modified augmented graph model, the user accounts represented in the modified augmented graph model into a plurality of groups.

2. The method of claim 1, wherein the grouping results in a first set of user accounts being grouped into a first group and a second set of user accounts being grouped into a second group, the method further comprising:
processing, by the computer system, subsequent transactions involving the first set of user accounts according to a first policy; and
processing, by the computer system, subsequent transactions involving the second set of user accounts according to a second policy, wherein the second policy has one or more higher risk thresholds than the first policy.

3. The method of claim 1,
wherein determining whether to cluster the additional node with one of the attribute clusters includes:
determining respective distances between the additional node and one or more existing cluster nodes,
determining that the particular cluster node is closest to the additional node, and
determining that a distance between the particular cluster node and the additional node is below a threshold.

4. The method of claim 3,
wherein, prior to receiving the additional information, each weighted attribute edge connecting the particular cluster node to nodes in the particular attribute cluster has a same weight; and
wherein the additional attribute edge is initialized using the same weight.

5. The method of claim 1,
wherein determining whether to cluster the additional node with one of the attribute clusters includes:
determining respective distances between the additional node and one or more existing cluster nodes, and
based on determining that none of the respective distances are below a threshold, generating the particular attribute cluster for the additional node, wherein the particular cluster node is inserted into the particular attribute cluster.

6. The method of claim 5, wherein the additional attribute edge is initialized using a weighted degree of the additional node within the graph model.

7. The method of claim 1,
wherein, prior to receiving the additional information, the weighted attribute edges were trained by applying a modularity maximization algorithm to the augmented graph model, and
wherein grouping the user accounts represented in the modified augmented graph model includes adjusting weights of one or more of the weighted attribute edges.

8. The method of claim 1, further comprising:
accessing, by the computer system, groupings of the recipient user accounts generated by applying one or more modularity algorithms to the augmented graph model;
wherein grouping the user accounts represented in the modified augmented graph model includes, determining a grouping for the additional recipient user account by:
evaluating, with the computer system, a local modularity resulting from grouping the additional node into a particular group of user accounts into which a neighboring node of the additional node has been grouped; and
based on the evaluating, grouping, with the computer system, the additional node into the particular group.

9. The method of claim 8 further comprising:
subsequent to grouping the additional node into the particular group, updating, with the computer system, weights of one or more weighted attribute edges in the augmented graph model.

10. The method of claim 9, further comprising:
subsequent to the updating, reevaluating the grouping of the user account using modularity refinement.

11. A non-transitory, computer-readable medium storing instructions that when executed by a computer system cause the computer system to perform operations comprising:
accessing, at a computer system, an augmented graph model of (a) a set of transactions previously performed between respective pairs of initiator user accounts of a service and recipient user accounts of the service and (b) attribute values for a subset of the recipient user accounts,
wherein the augmented graph model includes cluster nodes that:
(a) have been inserted into attribute clusters identified within the augmented graph model and
(b) are connected by weighted attribute edges to attributed nodes of the augmented graph model, wherein the attributed nodes are nodes that correspond to recipient user accounts having attribute values;
receiving, at the computer system, additional information indicative of an additional transaction involving an additional recipient user account that is not represented in the augmented graph model with a node;
modifying, by the computer system using the additional information, the augmented graph model by:
representing the additional recipient user account as an additional node in the augmented graph model,
if the additional node is within a threshold distance of one or more cluster nodes, connecting the additional node to a nearest cluster node with an additional weighted attribute edge; and
if the additional node is outside of a threshold distance from any cluster nodes, inserting an additional cluster node into the augmented graph model and connecting the additional node to the additional cluster node with an additional weighted attribute edge; and
grouping, with the computer system by applying one or more modularity algorithms to the modified augmented graph model, the user accounts represented in the modified augmented graph model into a plurality of groups.

12. The non-transitory, computer-readable medium of claim 11, wherein the grouping results in a first set of user accounts being grouped into a first group and a second set of user accounts being grouped into a second group, wherein the operations further comprise:
processing, by the computer system, subsequent transactions involving the first set of user accounts according to a first policy; and
processing, by the computer system, subsequent transactions involving the second set of user accounts according to a second policy, wherein the second policy has one or more higher risk thresholds than the first policy.

13. The non-transitory, computer-readable medium of claim 11,
wherein, prior to receiving the additional information, the weighted attribute edges were trained by applying a modularity maximization algorithm to the augmented graph model, and
wherein grouping the user accounts represented in the modified augmented graph model includes adjusting weights of one or more of the weighted attribute edges.

14. The non-transitory, computer-readable medium of claim 11, wherein the operations further include:
accessing, by the computer system, groupings of the recipient user accounts generated by applying one or more modularity algorithms to the augmented graph model;
wherein grouping the user accounts represented in the modified augmented graph model includes, determining a grouping for the additional recipient user account by:
evaluating, with the computer system, a local modularity resulting from grouping the additional node into a particular group of user accounts into which a neighboring node of the additional node has been grouped; and
based on the evaluating, grouping, with the computer system, the additional node into the particular group.

15. The non-transitory, computer-readable medium of claim 11,
wherein the threshold is the greatest distance, prior to receiving the additional information, between any particular attribute node and a respective cluster node to which the particular attributed node is connected by a respective weighted attribute edge.

16. A non-transitory, computer-readable medium storing instructions that when executed by a computer system cause the computer system to perform operations comprising:
generating an augmented graph model of (a) a set of transactions previously performed between respective pairs of user accounts of a service and (b) attribute values for a subset of the user accounts, wherein the augmented graph model includes
cluster nodes that have been inserted into attribute clusters identified within the augmented graph model; and
indications of groupings of user accounts generated by applying one or more modularity algorithms to the augmented graph model, wherein weighted attribute edges of the augmented graph model are trained based on the groupings of user accounts;
receiving, at the computer system, additional information indicative of an additional transaction involving an additional user account that is not represented in the augmented graph model with a node;
modifying, by the computer system using the additional information, the augmented graph model by:
representing the additional user account as an additional node in the augmented graph model,
if the additional node is within a threshold distance of one or more cluster nodes, connecting the additional node to a nearest cluster node with an additional weighted attribute edge; and
if the additional node is outside of a threshold distance from any cluster nodes, inserting an additional cluster node into the augmented graph model and connecting the additional node to the additional cluster node with an additional weighted attribute edge; and
grouping, with the computer system by applying one or more modularity algorithms to the modified augmented graph model, the user accounts represented in the modified augmented graph model.

17. The non-transitory, computer-readable medium of claim 16, wherein applying one or more modularity algorithms to the modified augmented graph model includes (a) applying a local modularity maximization algorithm to determine a group for the additional node, (b) adjusting one or more weighted attribute edges, and (c) applying a modularity refinement algorithm using the adjusted one or more weighted attribute edges.

18. The non-transitory, computer-readable medium of claim 16, wherein grouping the user accounts represented in the modified augmented graph model includes
determining that global modularity would increase if one or more particular user accounts were grouped in a second group, wherein the particular user accounts were grouped in a first group prior to receiving the additional information; and
in response to the determining, regrouping the particular user accounts from the first group the second group.

19. The non-transitory, computer-readable medium of claim 16, wherein grouping the user accounts represented in the modified augmented graph model includes
determining that global modularity would increase if first user accounts grouped in a first group and second user account grouped in a second group prior to receiving the additional information were regrouped together into the first group
in response to the determining, regrouping a set of the second user accounts into the first group.

20. The non-transitory, computer-readable medium of claim 16,
wherein, prior to receiving the additional information, the weighted attribute edges were trained by applying a modularity maximization algorithm to the augmented graph model, and
wherein grouping the user accounts represented in the modified augmented graph model into a plurality of groups includes adjusting weights of one or more of the weighted attribute edges.
